(19) United States
(12) Patent Application Publication
(10) Pub. No.: US 2018/0243953 A1
(43) Pub. Date: Aug. 30, 2018

(54) RESIN-MOLDING DEVICE, RESIN-MOLDING METHOD, AND METHOD FOR PRODUCING RESIN-MOLDED PRODUCT

(71) Applicant: TOWA CORPORATION, Kyoto-shi (JP)

(72) Inventors: Yusuke SHIMODA, Uji-shi (JP); Noriyuki TAKAHASHI, Otsu-shi (JP)

(73) Assignee: TOWA CORPORATION, Kyoto-shi (JP)

(21) Appl. No.: 15/887,380

(22) Filed: Feb. 2, 2018

(30) Foreign Application Priority Data
Feb. 24, 2017 (JP) 2017-033888

(51) Int. Cl. B29C 43/36; B29C 43/02

(52) U.S. Cl. CPC B29C 43/36; B29C 2043/366; B29C 43/02

(57) ABSTRACT

Provided is a resin-molding device 10 including: a first platen 11 and a second platen 12; a first molding die 161 to be attached to the first platen; a second molding die 162 to be attached to the second platen and arranged so as to face the first molding die; a die-clamping mechanism 133 for clamping the first and second molding dies together by decreasing the distance between the first and second platens, and for separating the first and molding dies from each other by increasing the distance between the first and second platens; and a flatness adjuster 14 including an adjustment member 141 for adjusting the parallelism between the die surface of the first molding die and that of the second molding die, or the flatness of a resin-molded product to be molded with the first and second molding dies.

### TECHNICAL FIELD

The present invention relates to a resin-molding device, resin-molding method, and method for producing a resin-molded product.

### BACKGROUND ART

It has been common to seal electronic parts with a resin material in order to protect the electronic parts from light, heat, moisture and other environmental factors. Patent Literature 1 discloses a resin-sealing device designed to obtain resin-sealed products free of qualitative variations even when the various resin-sealing conditions become different due to the shape of the product to be molded as well as other factors. The resin-sealing device includes: a section for supplying a product to be molded with resin (“target product”); a target-product measurement section for measuring the thickness of a semiconductor chip mounted on the target product; a resin supply section for supplying, to the target product, a liquid resin to be used for the resin sealing; a resin-molding section for resin-molding the target product supplied with the liquid resin by means of a sealing die; a molded-product measurement section for measuring the thickness of the resin-sealed portion of the molded product obtained through the resin-molding; a storage section for the molded product; and a control section for controlling each of these sections. The control section further includes a regulation means for regulating the amount of resin to be supplied to the target product through the resin supply section based on the results of the measurements by the measurement sections.

### CITATION LIST

### Patent Literature

Patent Literature 1: JP 2006-315184 A

Patent Literature 2: JP 2007-125783 A

Patent Literature 3: JP 2010-094931 A

### SUMMARY OF INVENTION

### Technical Problem

In the resin-sealing device described in Patent Literature 1, no consideration is given to the fact that the molding die or a member to which the molding die is attached may undergo distortion or similar deformation during the die-clamping process. Therefore, the problem of an unwanted deformation of the resin-molded product due to the deformation of the molding die or other related members has been inevitable.

The problem to be solved by the present invention is to provide a resin-molding device, resin-molding method, and method for producing a resin-molded product which can prevent the resin-molded product from being significantly affected even when the molding die or a member to which the molding die is attached is deformed due to the die-clamping operation.

### Solution to Problem

One mode of the resin-molding device according to the present invention developed for solving the previously described problem includes:

a) a first platen and a second platen;

b) a first molding die to be attached to the first platen;

c) a second molding die to be attached to the second platen and arranged so as to face the first molding die;

d) a die-clamping mechanism for clamping the first molding die and the second molding die together by decreasing the distance between the first platen and the second platen, and for separating the first molding die and the second molding die from each other by increasing the distance between the first platen and the second platen; and

e) a flatness adjuster including an adjustment member for adjusting the parallelism between the die surface of the first molding die and the die surface of the second molding die, or the flatness of a resin-molded product to be molded with the first molding die and the second molding die.

Another mode of the resin-molding device according to the present invention developed for solving the previously described problem includes:

a) a first platen and a second platen;

b) a first molding die to be attached to the first platen;

c) a second molding die to be attached to the second platen and arranged so as to face the first molding die, the second molding die including a bottom-surface member and a side-surface member constituting a cavity;

d) a die-clamping mechanism for clamping the first molding die and the second molding die together by decreasing the distance between the first platen and the second platen, and for separating the first molding die and the second molding die from each other by increasing the distance between the first platen and the second platen; and

e) a flatness adjuster to be arranged between the first platen and the first molding die, the flatness adjuster including an adjustment member for adjusting the parallelism between the die surface of the first molding die and the die surface of the second molding die, or the flatness of a resin-molded product to be molded with the first molding die and the second molding die.

One mode of the resin-molding method according to the present invention developed for solving the previously described problem includes:

a preparation process including a step of preparing: a first platen and a second platen; a first molding die to be attached to the first platen; a second molding die to be attached to the second platen and arranged so as to face the first molding die; a die-clamping mechanism for clamping the first molding die and the second molding die together by decreasing the distance between the first platen and the second platen, and for separating the first molding die and the second molding die from each other by increasing the distance between the first platen and the second platen; and a flatness adjuster including an adjustment member for adjusting the parallelism between the die surface of the first molding die and the die surface of the second molding die, or the flatness of a resin-molded product to be molded with the first molding die and the second molding die; and

a die-clamping process including a step of clamping the first molding die and the second molding die together.

Another mode of the resin-molding method according to the present invention developed for solving the previously described problem includes:

a preparation process including a step of preparing: a first platen and a second platen; a first molding die to be attached to the first platen; a second molding die to be attached to the second platen and arranged so as to face the first molding die, the second molding die including a bottom-surface member and a side-surface member constituting a cavity; a die-clamping mechanism for clamping the first molding die and the second molding die together by decreasing the distance between the first platen and the second platen, and for separating the first molding die and the second molding die from each other by increasing the distance between the first platen and the second platen; and a flatness adjuster to be arranged between the first platen and the first molding die, the flatness adjuster including an adjustment member for adjusting the parallelism between the die surface of the first molding die and the die surface of the second molding die, or the flatness of a resin-molded product to be molded with the first molding die and the second molding die;

a target-object supply process including a step of supplying an object to be molded to the first molding die;

a resin-material supply process including a step of supplying a resin material to the cavity of the second molding die; and

a die-clamping process including a step of clamping the first molding die and the second molding die together.

A method for producing a resin-molded product according to the present invention developed for solving the previously described problem includes a step of producing a resin-molded product by the resin-molding method according to the present invention.

### Advantageous Effects of the Invention

With the resin-molding device, resin-molding method, or method for producing a resin-molded product according to the present invention, it is possible to prevent the resin-molded product from being significantly affected even when the molding die or a member to which the molding die is attached is deformed due to the die-clamping operation.

### BRIEF DESCRIPTION OF DRAWINGS

FIG. 1A is a side view showing the first embodiment of the resin-molding device according to the present invention, and FIG. 1B is a partially enlarged view of the device.

FIGS. 2A and 2B are diagrams illustrating a flatness adjuster of the resin-molding device in the first embodiment.

FIGS. 3A-3F are diagrams illustrating an operation of the resin-molding device in the first embodiment.

FIGS. 4A-4D are a continuation of the diagrams illustrating the operation of the resin-molding device in the first embodiment.

FIG. 5 is a schematic diagram of a resin-molded product.

FIGS. 6A-6C show one example of the process of adjusting the adjustment members in the flatness adjuster based on the result of a die-clamping test.

FIG. 7 is a partially enlarged view of a variation of the resin-molding device in the first embodiment.

FIG. 8 is a side view showing the second embodiment of the resin-molding device according to the present invention (left), and a partial enlarged view of the device (right).

FIG. 9 is a plan view showing an example of the resin-molding device according to the present invention, which includes a plurality of molding modules connected.

### DESCRIPTION OF EMBODIMENTS

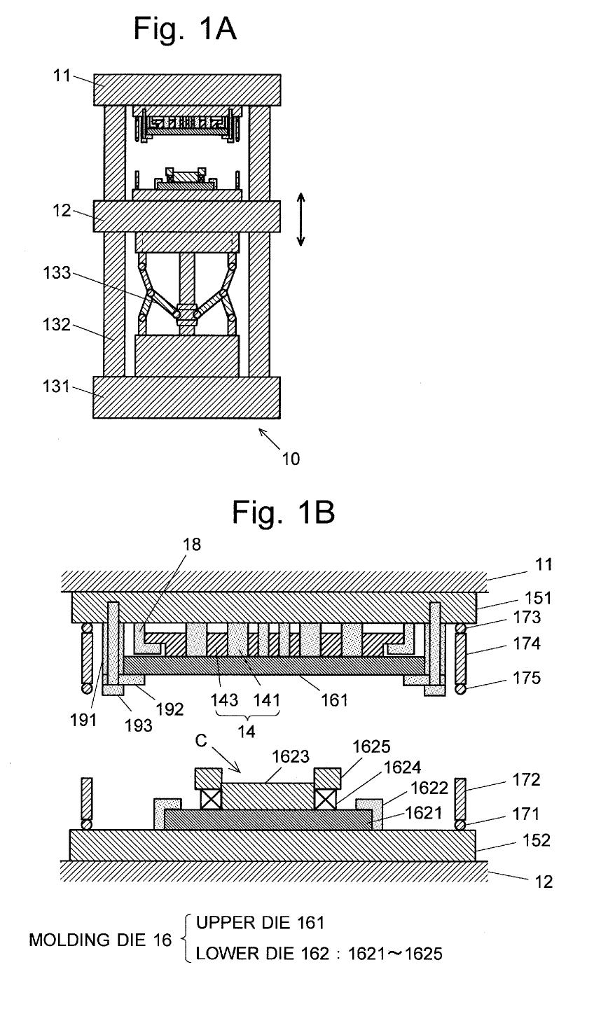

Embodiments of the resin-molding device, resin-molding method, and method for producing a resin-molded product are hereinafter described using FIGS. 1A-9.

### (1) First Embodiment

### (1-1) Configuration of Resin-Molding Device 10 in First Embodiment

FIG. 1A shows an overall configuration of a resin-molding device 10 in the present embodiment, and FIG. 1B shows a configuration of the main components around a molding die 16 in the resin-molding device 10.

The resin-molding device 10 in the present embodiment is constructed on a pedestal 131 placed on a floor, the pedestal having a rectangular shape on a plan view. Four vertical tie bars 132 are respectively provided at the four corners of the pedestal 131 (only two of the tie bars 132 are shown). A first platen (upper platen, which corresponds to the fixed platen in the present invention) 11 and second platen (lower platen, which corresponds to the movable platen in the present invention) 12 are arranged above the pedestal 131. The upper ends of the tie bars 132 are respectively connected to the four corners of the first platen 11, thereby holding the first platen 11 in the immobile state. The second platen 12 have through-holes formed at its four corners, through which the tie bars 132 are inserted, thereby allowing for the vertical movement of the second platen 12. A toggle link 133 which is the drive mechanism for making the second platen 12 vertically move (the die-clamping mechanism in the present invention) is located between the pedestal 131 and the second platen 12. The toggle link 133 has two toggle mechanisms. The points of action of the two toggle mechanisms are attached to the lower surface of the second platen 12. Within the space between the first and second platens 11 and 12, a molding die 16 and other elements are arranged, as will be described later. Although the resin-molding device 10 in the present embodiment has the first (upper) platen 11 provided as the fixed platen in the immobile state and the second (lower) platen 12 provided as the movable platen, the states of the two platens may be reversed. It is also possible to provide both first and second platens 11 and 12 as movable platens. In that case, each of the first and second platens 11 and 12 should be provided with the toggle link 133 or similar die-clamping mechanism. In place of the toggle link 133 used in the drive mechanism (die-clamping mechanism) in the present embodiment, a different type of die-clamping mechanism may be used, such as a hydraulic or pneumatic drive mechanism, or a die-clamping mechanism which uses a ball screw or similar element.

Below the first platen 11, an upper heater plate 151, flatness adjuster 14, and upper die 161 (the first molding die in the present invention) of the molding die 16 are sequentially arranged in the top-to-bottom direction. A heater plate is a plate member made of a metal, such as iron, stainless steel or Ti-6Al-4V alloy, in which a heater is embedded. It should be noted that the components in the present embodiment as well as their order of arrangement are mere examples. The configuration of those components and their order of arrangement may be appropriately changed as long as the flatness adjuster 14 is located at such a position where it can adjust the parallelism between the die surface of the upper die 161 (the first molding die in the present invention) and that of a lower die 162 (the second molding die in the present invention), or the flatness of a resin-molded product to be molded with the molding die 16. The upper die 161 of the molding die 16 is located at the die arrangement section of the first platen 11 In many cases, this die arrangement section is located in a central area on the plate surface of the first platen 11, although it does not always need to be in that area. The die surface of the upper die 161 is the surface which faces the lower die 162 and includes, for example, the surface to which a substrate 22 should be attached. The die surface of the lower die 162 is the surface which faces the upper die 161 and includes, for example, the bottom surface of cavity C (this surface is the upper surface of a bottom-surface member 1623, which will be described later). An upper ambient air blockage member 174 fitted with O-rings 173 and 175 at its upper and lower ends is arranged along the circumferential edge of the lower surface of the first platen 11. During the die-clamping operation of the molding die 16, the space in which the molding die 16 is located is shielded from the surrounding area by the O-ring 173, upper ambient air blockage member 174 and O-ring 175 as well as a lower ambient air blockage member 172 and O-ring 171, which will be described later.

Above the second platen 12, a lower heater plate 152 and the lower die 162 (the second molding die in the present invention) of the molding die 16 are arranged. The lower die 162 of the molding die 16 is located at the die arrangement section of the second platen 12. This die arrangement section also does not always need to be in the central area on the plate surface of the second platen 12, although the upper and lower dies 161 and 162 must be arranged so that they directly face each other. The lower die 162 includes: a lower-die base plate 1621; a lower-die side block 1622 which is a member for guiding the lower-die base plate 1621 into the die arrangement section; a bottom-surface member 1623 fixed to the central portion on the upper surface the lower-die base plate 1621; and a side-surface member 1625 shaped like a frame surrounding the bottom-surface member 1623 and arranged on the upper surface of the lower-die base plate 1621 via an elastic member 1624, such as a spring. In a resin-molding process (which will be described later), the cavity C is formed by the upper surface of the bottom-surface member 1623 and the inner side surface of the side-surface member 1625. The lower ambient air blockage member 172 is arranged along the circumferential edge of the upper surface of the second platen 12 via the O-ring 171.

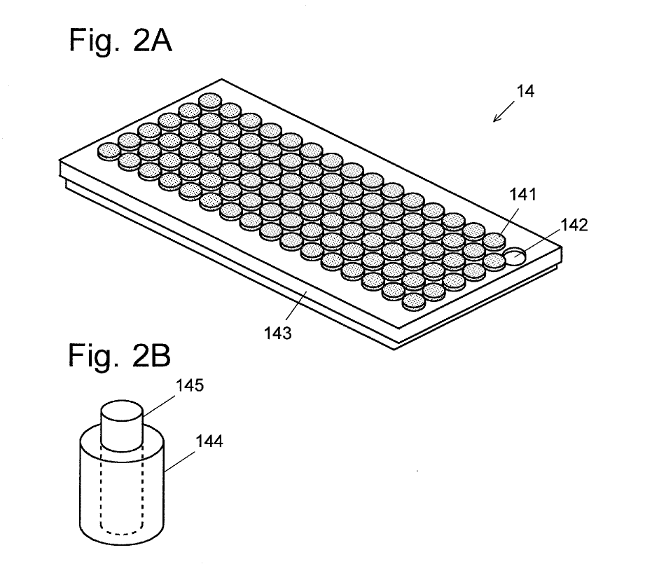

As shown in FIG. 2A, the flatness adjuster 14 includes: a plurality of cylindrical adjustment members 141; and an adjustment member container 143 in which a plurality of adjustment member holder portions 142 each of which can hold one adjustment member 141 are arranged in a grid-like form. The depth of the adjustment member holder portions 142 is smaller (shallower) than the height of the adjustment members 141. Accordingly, when an adjustment member 141 is placed in an adjustment member holder portion 142, the upper portion of the adjustment member 141 protrudes from the adjustment member holder portion 142. The adjustment members 141 in the present embodiment are made of one kind of metal (which may be an alloy) having a high level of thermal conductivity to efficiently conduct the heat from the upper heater plate 151 to the upper die 161. Although this is a preferable mode, it is not essential for the present invention to have the adjustment members 141 made of a metal having a high level of thermal conductivity. In FIG. 2A, the adjustment members 141 are placed in all but one adjustment member holder portion 142. In a practical use, the adjustment members 141 may be placed in some of the adjustment member holder portions 142 while leaving the other adjustment member holder portions 142 empty, thereby creating a variation in the local density of the adjustment members 141 in the adjustment member container 143 so as to correct distortion, curving or similar deformation of the die surface (the surface which faces the lower die 162) of the upper die 161 which occurs in the resin-molding process. The flatness adjuster 14 is mounted by having the lower surface of the adjustment member container 143 supported from both sides by adjustment-mechanism side blocks 18 which have an L-shaped cross section and are fixed to the upper heater plate 151.

In FIG. 2A, the adjustment members 141 placed in the adjustment member holder portions 142 are all made of the same kind of metal and have the same height and cross-sectional area. It is also possible to use adjustment members which vary in rigidity (material) or height, or both. Furthermore, as shown in FIG. 2B, an attachment 144 having an outer diameter and height substantially equal to the inner diameter (hole diameter) and depth of the adjustment member holder portion 142, with a through-hole formed inside, may be used to allow for the use of an adjustment member 145 which has a smaller diameter (or is thinner) than the adjustment member holder portion 142. The attachment 144 allows the thinner adjustment members 145 to be placed in some of the adjustment member holder portions 142 in the adjustment member container 143, while the thicker (normal) adjustment members 141 are placed in some other adjustment member holder portions 142. Furthermore, in place of the cylindrical adjustment member 141 used in FIG. 2A, an adjustment member 141 having a different shape (e.g. a polygonal or elliptical column) may also be used.

The flatness adjuster 14 in the present embodiment is located between the upper heater plate 151 and the upper die 161. It is also possible to arrange the flatness adjuster 14 between the lower die 162 and the lower heater plate 152. That is to say, the flatness adjuster 14 can be located at one or both of the upper and lower dies 161 and 162.

An upper-die side block 191 fixed to the upper heater plate 151 is located on the lateral side of the upper block 161. A pressing plate 192 (the support member in the present invention) for supporting the upper die 161 is attached to the lower end of the upper-die side block 191. The pressing plate 192 is fixed with a bolt 193 (the fixation member in the present invention) which is inserted through the pressing plate 192 and the upper-die side block 191 into a screw hole formed in the upper heater plate 151. Loosening the bolt 193 allows the pressing plate 192 and the upper die 161 to move downward, thereby allowing the upper die 161 to be replaced as needed. That is to say, the upper-die side block 191, pressing plate 192 and bolt 193 constitute a mechanism corresponding to the attachment mechanism in the present invention. The attachment mechanism allows the upper die 161 to be attached to the first platen 11 in a freely removable form.

### (1-2) Operation of Resin-Molding Device 10 in First Embodiment

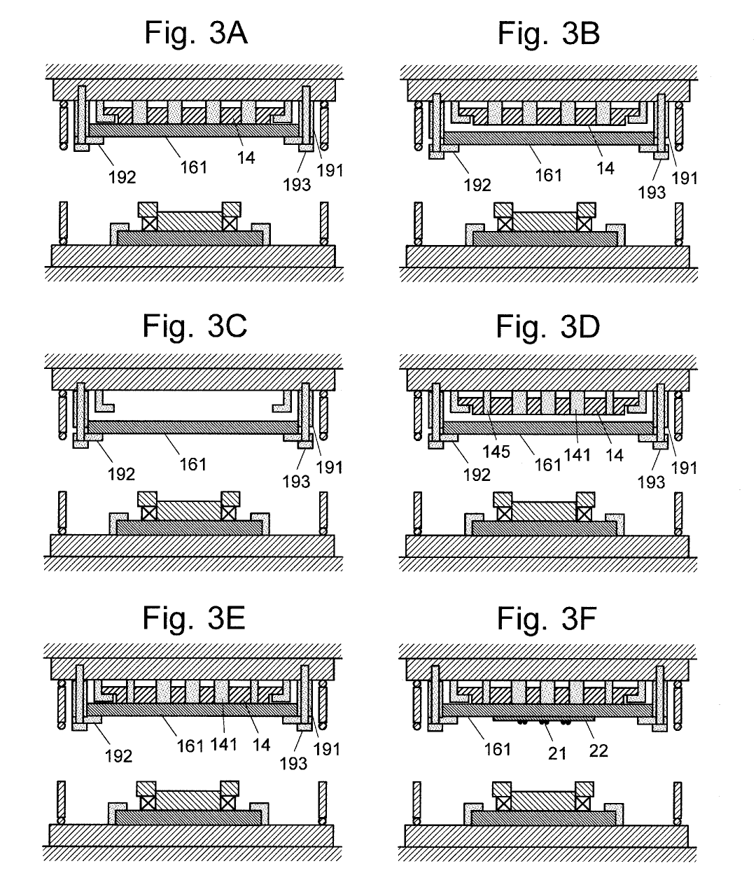

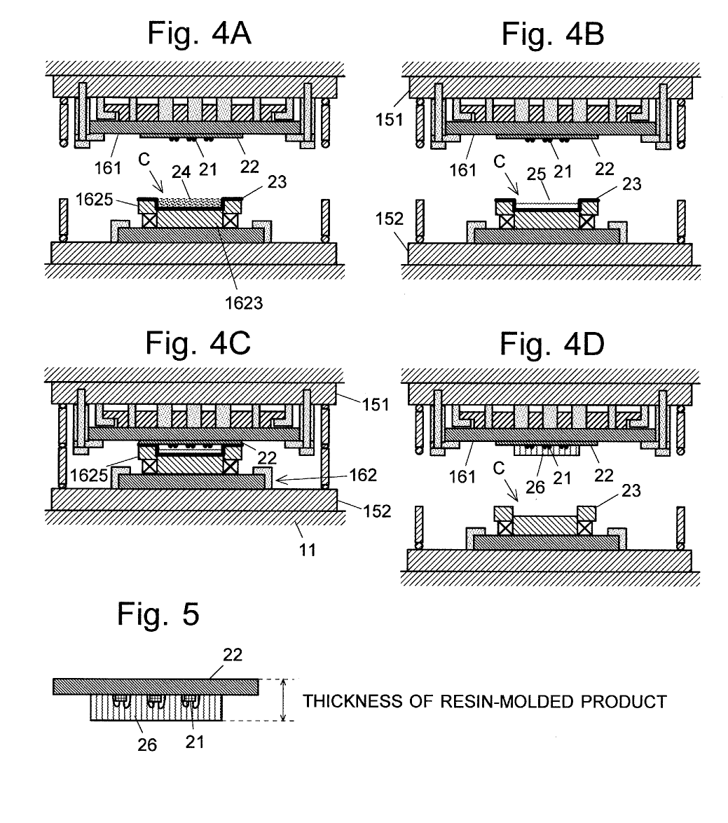

An operation of the resin-molding device 10 in the first embodiment is hereinafter described using FIGS. 3A-4D. The resin-molding device 10 in the present embodiment can be used for resin-molding various plate-shaped members (e.g. metal substrate, resin substrate, glass substrate, ceramic substrate, circuit board, semiconductor wafer, or lead frame). In the example which will be hereinafter described, the object to be molded is a substrate 22 on which electronic parts 21 are mounted, and a resin-sealed product including the electronic parts 21 sealed with a cured resin 26 is created. Other kinds of resin-molded products can also be similarly created.

FIG. 3A is an enlarged view of the molding die 16 and its surroundings in the resin-molding device 10 before the adjustment of the flatness adjuster 14.

The adjustment of the flatness adjuster 14 is performed as follows: Initially, the bolt 193 is loosened to make the upper die 161 move downward along with the pressing plate 192 (FIG. 3B). Subsequently, the flatness adjuster 14 is slid frontward (or rearward) in the figure and removed (FIG. 3C). Thus, the resin-molding device 10 in the present embodiment is provided with the pressing plate 192 for supporting the upper die 161, and the bolt 193 for fastening or releasing the pressing plate 192 onto or from the first platen 11 while supporting the upper die 161 with the pressing plate 192. These elements are configured so that the flatness adjuster 14 can be inserted into or removed from the space between the first platen 11 and the upper die 161 without removing the upper die 161 when the pressing plate 192 is released from the first platen 11. If the device were configured so that the molding die 16 (upper die 161 and/or lower die 162) must be removed in the process of detaching or attaching the flatness adjuster 14, the time and labor for detaching and attaching the molding die 16 would be additionally required. Detaching the molding die 16 from the resin-molding device 10 also causes the problem that the molding die 16 becomes cooled and requires a longer period of time to be heated to the predetermined temperature after it has once more been attached. The resin-molding device 10 in the present embodiment is free from those problems, since the flatness adjuster 14 can be removed without requiring the upper die 161 to be detached from the resin-molding device 10. Accordingly, the adjustment of the flatness adjuster 14 as well as the resin-molding process can be efficiently performed. Needless to say, the upper die 161 may also be detached and attached as needed in the process of detaching and attaching the flatness adjuster 14.

The next step is to change the arrangement of the adjustment members 141 placed in the adjustment member holder portions 142 of the detached flatness adjuster 14 as well as the height, diameter (cross-sectional area) and/or rigidity (material) of the adjustment members 141 to be used. Specifically, the arrangement and/or other factors related to the adjustment members 141 are changed so that a predetermined degree of parallelism is achieved between the die surface of the upper die 161 and that of the lower die 162 when the molding die 16 is clamped, with the result that the resin-molded product to be eventually molded with the molding die 16 will have a predetermined degree of flatness. For example, if a resin-molded product prepared in a die-clamping test (which will be described later) has a local portion that is thicker than the other portions, adjustment members 141 having a larger diameter (cross-sectional area) are arranged at and near the thick portion, while adjustment members having a smaller diameter (cross-sectional area) are arranged at the other portions. By this arrangement, the flatness of the resin-molded product is maintained and the variation in its thickness is reduced. If the flatness adjuster 14 is also provided between the lower die 162 and the lower heater plate 152, the flatness of the resin-molded product can be adjusted on both the upper and lower sides, whereby the degree of freedom of the adjustment is increased and the flatness of the resin-molded product can be more finely adjusted. In the present embodiment, adjustment members 141 with a larger cross-sectional area are arranged in the central region, while adjustment members 145 with a smaller cross-sectional area are arranged in the peripheral region. After the adjustment members 141 and 145 have been rearranged, the flatness adjuster 14 is once more loaded in the resin-molding device 10 (FIG. 3D). Subsequently, the bolt 193 is tightened to drive the pressing plate 192 and upper die 161 upward to a position where they firmly hold the flatness adjuster 14 (FIG. 3E). The preparation process in the resin-molding method according to the present invention corresponds to the process in which the resin-molding device including the aforementioned members is made to be ready for use, as shown in FIG. 3A, while FIGS. 3B-3E correspond to the process of adjusting the flatness of the resin-molded product using the flatness adjuster 14 (or the process of adjusting the parallelism of the die surfaces in the molding die).

After the flatness adjuster 14 has been fixed, the upper and lower heater plates 151 and 152 are energized. Subsequently, the object to be molded, i.e. the substrate 22 on which the electronic parts 21 are mounted, is attached to a predetermined position on the upper die 161 (FIG. 3F). In the present embodiment, the substrate 22 is fastened to the upper die 161 with a vacuum suction device (not shown) provided in the upper die 161. A different method, such as the use of a fixture, may be used to fasten the substrate 22 to the upper die 161. Although the energization of the upper and lower heater plates 151 and 152 in the present embodiment is performed after the fixation of the flatness adjuster 14 and before the fastening of the substrate 22 to the upper plate 161, the timing of energizing the upper and lower heater plates 151 and 152 may be appropriately changed as long as the upper and lower dies 161 and 162 can be heated to a predetermined temperature before the operation of clamping the molding die 16 is initiated.

After the substrate 22 has been fastened to the upper die 161, a release film 23 is attached so as to cover the cavity C of the lower die 162. The release film 23 is tightly fitted onto the upper surface and inner wall surface of the side-surface member 1625 as well as the upper surface of the bottom-surface member 1623 with a suction mechanism (not shown) provided in the lower die 162. Subsequently, a predetermined amount of granular or powdery resin material 24 is supplied into the cavity C in which the release film 23 has been fitted (FIG. 4A). The resin material 24 supplied into the cavity C in the lower die 162 is heated to a predetermined temperature (e.g. 170-180° Q by the lower heater plate 152 via the lower die 162, while the substrate 22 is also heated to the same temperature by the upper heater plate 151 via the upper die 161, so that the resin material 24 begins to melt (FIG. 4B). In the present embodiment, the resin material 24 is supplied after the release film 23 has been fitted in the cavity C. However, the release film and the resin material may be supplied by a different method, such as simultaneously supplying the release film and the resin material into the cavity C. This can be achieved, for example, by supplying the resin material onto a resin receiver formed by spreading the release film on the bottom side of a frame member, transferring the resin receiver onto the top of the cavity C, and making the release film and the resin material both fall into the cavity C. The type of resin material is not limited to the granular or powdery thermosetting resin material as used in the present embodiment. For example, a liquid resin, sheet-like resin, tablet-like resin material or the like may also be used other than the granular or powdery resin material. Furthermore, other than the thermosetting resin, such as an epoxy resin or silicone resin, a thermoplastic resin can also be used. In the case of using a thermosetting resin which is in the liquid state at room temperature, after its viscosity is temporarily lowered by heating, the resin is further heated until it is cured (set). A composite material which partially contains a thermosetting or thermoplastic resin (mixed with another material) may also be used.

Next, the toggle link 133 is operated to drive the second platen 12 upward. The lower heater plate 152 and the lower die 162 placed on the second platen 12 are thereby lifted. In this motion, the upper surface of the side-surface member 1625 initially comes in contact with the lower surface of the substrate 22. The second platen 12 and other components in this state are further lifted, whereby the elastic member 1624 is compressed, allowing the bottom-surface member 1623 to move upward in relation to the side-surface member 1625, and the electronic parts 21 mounted on the substrate 22 are immersed in the molten resin 25. In this state, the molding die 16 is clamped (FIG. 4C). The die is maintained in the clamped state for a certain period of time, and the molten resin 25 is additionally heated. Consequently, the molten resin 25 is cured, and the electronic parts 21 are sealed with the cured resin 26. After the resin-sealing process, the toggle link 133 is once more operated to make the second platen 12 move downward and thereby open the molding die 16 (FIG. 4D). Since the release film 23 is fitted in the cavity C in the present embodiment, the cured resin 26 can be smoothly removed from the cavity C, and the resin-molded product can be thereby released from the die. In the present embodiment, the processes described thus far correspond to the resin-molding method.

After the resin-sealed product created by the resin-molding method according to the present embodiment is removed, a circumferential portion of the product is cut off to remove unnecessary portions of the cured resin. If a plurality of electronic parts are collectively sealed with resin as in the previously described example, the product is cut at predetermined positions to obtain the individual parts. That is to say, it is often the case that an intermediate product created by the resin-molding method needs to be further processed to be the completed product. The method for producing a resin-sealed product (resin-molded product) in the present embodiment includes such a process in addition to the processes of the previously described resin-sealing method (resin-molding method).

A method of adjusting the flatness adjuster 14 included in the resin-molding device 10 as a characteristic component in the present embodiment is hereinafter described.

FIG. 5 is a schematic diagram of one example of the resin-molded product produced by the resin-molding device 10 in the present embodiment. As described earlier, this resin-molded product includes the electronic parts 21 mounted on the substrate 22 and sealed with the cured resin 26. As shown in FIG. 5, the thickness of the resin-molded product equals the sum of the thickness of the substrate 22 and that of the resin-sealed portion. In many cases, the thickness of the resin-molded product is within a range from several hundred μm to several mm. The variation in local thickness (i.e. the difference in thickness between the thickest and thinnest portions) of such a resin-molded product must be no greater than 100 μm. Particularly, in recent years, this variation for some cases has been required to be 10 μm or even smaller. In summary, there has been a demand for eliminating the variation in the local thickness of resin-molded products and thereby improving the flatness of the resin-molded products.

The first platen 11, second platen 12, upper heater plate 151, lower heater plate 152, upper die 161, lower die 162 and other members of the resin-molding device 10 each have a variation in shape at the point of production within their respective tolerances. The variation in the shape of each individual member is small. However, when those members are assembled or attached as parts of the resin-molding device 10, the variations in their respective shapes are accumulated to such an extent that affects the parallelism of the die surfaces in the molding die 16. If the resin-sealing process is performed using the molding die 16 with the parallelism of its die surfaces deteriorated, the flatness of the resin-molded product to be eventually obtained will also be significantly deteriorated. Besides, during the process of clamping the molding die 16, the toggle link 133 applies force to two points (in the example of the present embodiment) on the second platen 12 to drive this platen upward, while the first platen 11, which is immobile, is pulled downward at the portions to which the four tie bars 132 (in the example of the present embodiment) are fixed. That is to say, in each of the first and second platens 11 and 12, an amount of force is locally applied at specific locations, which may also lower the parallelism of the die surfaces in the molding die 16 and thereby deteriorate the flatness of the resin-molded product. In a conventional case, if the first platen 11 is distorted in the die-clamping process, the distortion is directly reflected in the upper die 161 and may possibly deteriorate the flatness of the resin-sealed product. In the present embodiment, even in the case where the upper die 161 is distorted in the die-clamping process, the effect of the variation in its shape can be reduced by appropriately adjusting the arrangement and/or other factors related the adjustment members 141 in the flatness adjuster 14 so as to constantly maintain the flatness of the resin-molding product.

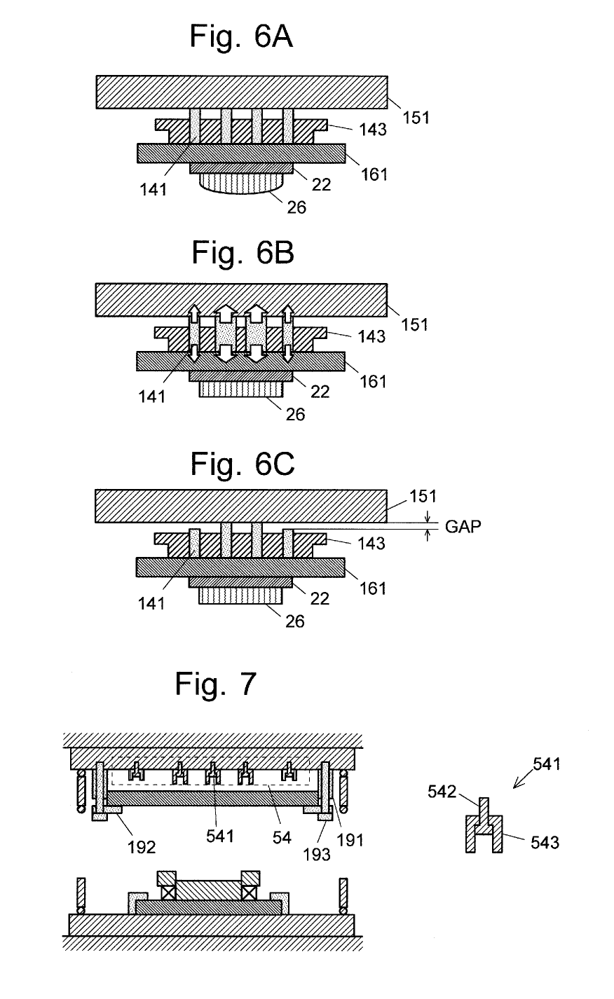

It is difficult to exactly identify all factors that affect the parallelism of the die surfaces in the molding die 16 and the flatness of the resin-molded product, since there are various factors other than the tolerances of the related members as well as the force which acts during the process of clamping the molding die 16 as mentioned earlier; for example, in the heating process using the heater plates, the temperature of each member may slightly vary depending on the location and cause an uneven deformation. However, it is possible to previously investigate the variation in the flatness of the resin-molded product due to such factors, for example, by a preliminary die-clamping test. In the die-clamping test, as shown in FIG. 6A, a test sample is created by a resin-molding process in which the die-clamping operation is performed with the same adjustment members 141 uniformly arranged in the molding die 16, and the flatness of the test sample is measured. For example, as shown in FIG. 6A, if the test piece (or its cured resin 26) is thicker at its central portion and thinner at its peripheral portion, the thicker (normal) adjustment members 141 can be arranged at the central portion, and the adjustment members having a smaller diameter (cross-sectional area) can be arranged at the peripheral portion, as shown in FIG. 6B. For example, it is possible to consider that the pressing force (load) from the molding die at the position where the resin-molded product has the thicker sealing resin (cured resin 26) is smaller than at the other positions (where the sealing resin is thinner). In other words, it is possible to consider that a variation in the pressing force from the molding die 16 depending on the position has caused the amount of displacement of the molding die in the die-clamping process to vary with the position, so that the sealing resin has become non-uniform in thickness. By arranging the thicker adjustment members 141 (which are less likely to buckle) at the position with the thicker sealing resin and the thinner adjustment members (which are more likely to buckle) at the position with the thinner sealing resin as shown in FIG. 6B, the pressing force (load) on the upper die 161 can be increased to make the sealing resin be uniform in thickness (i.e. levelled). Alternatively, as shown in FIG. 6C, taller adjustment members 141 may be arranged at the central portion, while shorter ones are arranged at the peripheral portion, to adjust the magnitude of the force which acts during the process of clamping the molding die 16, and thereby constantly maintain the flatness of the resin-sealed product. In this case, the pressing force in the die-clamping process initially acts on the area where the taller adjustment members are located. As the die is further clamped, the upper die 161 and/or upper heater plate 151 begins to be gradually deformed and comes in contact with the adjustment members at the positions where the shorter adjustment members are located, thereby causing the pressing force to act. In this manner, adjustment members which differ in height can also be used to adjust the amount of displacement of the molding die and thereby make the sealing resin be uniform in thickness. Thus, the possibility of defective products being produced (resin-molded products with a significant variation in the local thickness) is reduced.

### (1-4) Variation of Flatness Adjuster

The flatness adjuster 14 in the resin-molding device 10 according to the first embodiment is configured by setting the adjustment members 141 in the adjustment member container 143 in which the adjustment member holder portions 142 are provided. Alternatively, a flatness adjuster 54 as shown in FIG. 7 can also be used. The adjustment member 541 in this flatness adjuster 54 includes a bolt 542 with a screw thread formed at its tip portion and an adjustment pin 543 having a hole for inserting the bolt 542 formed at the center of its upper surface. A plurality of adjustment pins 543 which differ in height are provided. This flatness adjuster 54 is used as follows: Similarly to the previous embodiment, the bolt 193 is initially loosened to make the upper die 161 move downward. For each setting position, an adjustment pin 543 having an appropriate height is chosen and the bolt 542 is inserted into the hole at the upper surface of the same pin. The adjustment member 541 is fixed in one of a large number of screw holes which have previously been arranged in a two-dimensional form (in a grid-like or honeycomb pattern) on the lower surface of the upper heater plate 151. At this stage, the upper die 161 may also be removed for replacement as needed. After all adjustment members 541 have been set, the bolt 193 is tightened to drive the upper die 161 upward. Such a flatness adjuster 54 can also be used to maintain the parallelism of the die surfaces in the molding die 16 and the flatness of the resin-molded product in a similar manner to the resin-molding device 10 in the first embodiment. Needless to say, the cross-sectional area, position and/or rigidity (material) of the adjustment pin 543 may also be changed in addition to the height of the same pin 543, as with the adjustment member 141 in the resin-molding device according to the first embodiment.

### (2) Resin-Molding Device 30 in Second Embodiment

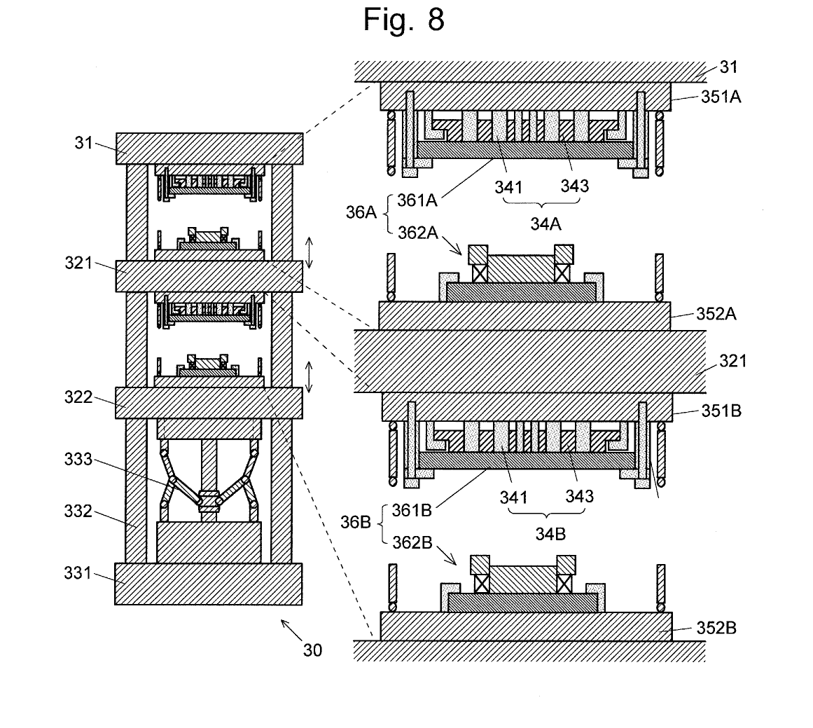

As shown in FIG. 8, the resin-molding device 30 according to the second embodiment is similar to the resin-molding device 10 according to the first embodiment in that four vertical tie bars 332 and the toggle link 333 are provided on the pedestal 331. An upper movable platen 321 and lower movable platen 322 are mounted on the tie bars 332 in a vertically moveable manner. A fixed platen 31 is fixed to the upper ends of the tie bars 332.

A first flatness adjuster 34A, first upper heater plate 351A, first lower heater plate 352A and first molding die 36A (first upper die 361A and first lower die 362A) are provided between the fixed platen 31 and the upper movable platen 321. Similarly, a second flatness adjuster 34B, second upper heater plate 351B, second lower heater plate 352B and second molding die 36B (second upper die 361B and second lower die 362B) are provided between the upper movable platen 321 and the lower movable platen 322. The first and second molding dies 36A and 36B are located at the same position (die arrangement section) on the plan view. The toggle link 333 is connected to the lower surface of the lower movable platen 322. The upper ends of the tie bars 332 are fixed to the lower surface of the fixed platen 31.

Similarly to the flatness adjuster 14 in the first embodiment, the first and second flatness adjusters 34A and 34B both include adjustment members 341 and an adjustment member container 343. It is naturally possible to use a flatness adjuster 541 which includes bolts 542 and adjustment pins 543 as in the previously described variation. A similar flatness adjuster may also be provided at the lower die of each molding die. As in the first embodiment, the number density (or height, cross-sectional area or rigidity (material)) of the adjustment members 341 in the present embodiment is set so as to maintain the parallelism of the die surfaces of the first and second molding dies 36A and 36B during the die-clamping process in the resin-molding device 30, and thereby make the resin-molded product uniform in flatness.

In the resin-molding device 30 according to the second embodiment, the lower movable platen 322 is driven upward by the toggle link 333, whereby the upper movable platen 321 is also driven upward via the second lower heater plate 352B, second molding die 36B, second upper heater plate 351B and second flatness adjuster 34B. The die-clamping operation is thereby performed in the space between the upper movable platen 321 and the lower movable platen 322 as well as in the space between the upper movable platen 321 and the fixed platen 31. In this manner, the device in the present embodiment can simultaneously clamp the two molding dies by a single operation of the toggle link 333, whereby the production efficiency of the resin-molded products is improved. In the present resin-molding device 30, the lower movable platen 322, second molding die 36B, upper movable platen 321 and other related members are sequentially driven upward by the operation of the toggle link 333. As a different configuration, the upper and lower movable platens 321 and 322 may be linked with each other through a linkage mechanism including a rack-and-pinion system (or the like) so that the upper and lower movable platens 321 and 322 move in an interlocked manner, e.g. so that the moving distance of the lower movable platen 322 becomes two times the moving distance of the upper movable platen 321 (for example, see Patent Literature 3).

### (3) Example of Modular Resin-Molding Device

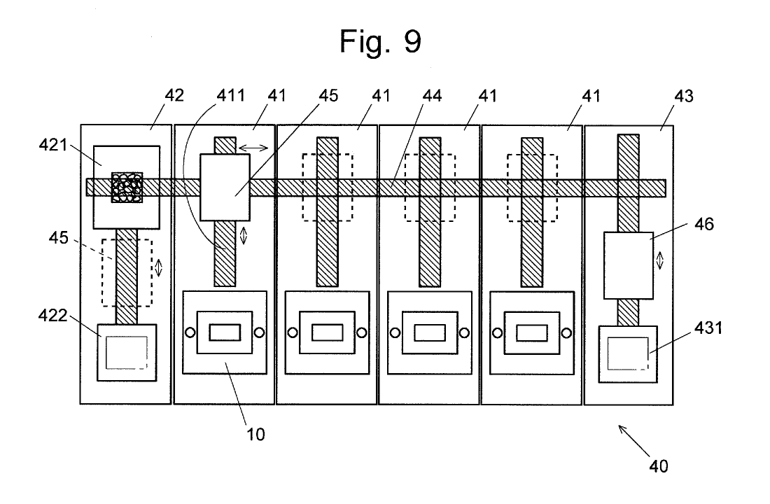

FIG. 9 shows a system 40 having one or more molding modules each of which includes the resin-molding device 10 according to the first embodiment. In other words, the resin-molding device 10 according to the first embodiment corresponds to one molding module. In the following description, the entire system 40 (resin-molding unit) in FIG. 9 is referred to as the “resin-molding system”. The resin-molding system 40 is hereinafter described with reference to FIGS. 1A and 9.

The resin-molding system 40 includes a plurality of molding modules 41, one resin-material-and-substrate refilling module 42, one resin-molded-product unloading module 43, and a transfer mechanism 44 penetrating through those modules. The resin-molding system 40 further includes: a resin-material-and-substrate supply device 45 which can be transferred between the resin-material-and-substrate refilling module 42 and the plurality of molding modules 41 by the transfer mechanism 44; and a resin-molded-product unloading device 46 which can be transferred between the plurality of molding modules 41 and the resin-molded-product unloading module 43 by the transfer mechanism 44. These components will be hereinafter described.

Each molding module 41 corresponds to one resin-molding device 10 in the first embodiment and additionally includes an auxiliary transfer mechanism 411 for transferring the resin-material-and-substrate supply device 45 and the resin-molded-product unloading device 46 between the transfer mechanism 44 and the resin-molding device 10.

The resin-material-and-substrate supply device 45, with a substrate 22 contained in its upper section and a resin material 24 (e.g. in a granular or powdery form) in its lower section, is transferred to a position near the resin-molding device 10 by the transfer mechanism 44 and the auxiliary transfer mechanism 411. Then, the device supplies the resin material 24 into the cavity C of the resin-molding device 10, and the substrate 22 into the upper die 161. For example, a device having a construction similar to the resin supply device described in Patent Literature 2 can be used as the device for supplying the resin material 24 into the cavity C. As for the device for supplying the substrate 22 into the upper die 161, a commonly known manipulator can be used. The resin-material-and-substrate refilling module 42 includes: a resin-material refilling device 421 having a hopper for refilling the resin-material-and-substrate supply device 45 with the resin material 24; and a substrate storage unit (magazine) 422 for storing the substrates 22 to be used for refilling the resin-material-and-substrate supply device 45. It is not always necessary to perform the supply of the substrate 22 and the resin material 24 through a single device; they can be supplied by using different devices. As already explained in the first embodiment, a configuration for simultaneously supplying the release film 23 and the resin material 24 into the cavity C may also be adopted.

The resin-molded-product unloading device 46 is transferred to a position near the resin-molding device 10 by the transfer mechanism 44 and the auxiliary transfer mechanism 411. Subsequently, by using the manipulator, the device removes the resin-molded product which includes the electronic parts 21 mounted on the substrate 22 and sealed with the cured resin 26, from the upper die 161 of the resin-molding device 10. The removed product is transferred to the resin-molded-product unloading module 43 by the auxiliary transfer mechanism 411 and the transfer mechanism 44. The resin-molded-product unloading module 43 includes a resin-molded-product storage unit (magazine) 431 for storing the resin-molded products which have been unloaded.

The molding modules 41 can be attached to and detached from each other in the direction in which the resin-material-and-substrate supply device 45 is transferred by the transfer mechanism 44 (the lateral direction in FIG. 9), thereby allowing for an after-adjustment (increase or decrease) of the number of modules as needed. Although a plurality of molding modules 41 are provided in the present example, the system may also be constructed with a single molding module.

With the resin-molding system 40 according to the present embodiment, after the process of supplying the resin material 24 into the cavity C and attaching the substrate 22 to the upper die 161 has been completed in one molding module 41, the supply of the resin material 24 and the attachment of the substrate 22 in another molding module 41 can be performed while the die-clamping process is being performed in the former molding module 41. This allows multiple tasks to be simultaneously performed in parallel in the plurality of molding modules 41 and thereby improves the production efficiency of the resin-molded products. The number of molding modules 41 can be freely increased or decreased as needed in the process of manufacturing the resin-molding system 40 or after the completion of the resin-molding system 40.

The resin-material-and-substrate refilling module 42 and the resin-molded-product unloading module 43 in the previously described resin-molding system 40 are provided as separate modules. However, the two modules may be integrated into a single module. That is to say, the resin-material refilling device 421, substrate storage unit 422 and resin-molded-product storage unit 431 may be included in a single module. Additionally, the resin-material-and-substrate refilling module 42 may also be provided with one resin-molding device 10 of the first embodiment. It is also possible to integrate the resin-material-and-substrate supply device 45 and the resin-molded-product unloading device 46 into a single device by using the same manipulator for both the supply of the substrate and the unloading of the resin-molded product.

Any of the previous embodiments is a mere example and can be appropriately changed within the spirit of the present invention.

Although any of the previously described embodiments is concerned with the case of the compression molding, the flatness adjuster and other members can similarly be applied in the case of performing the resin molding by a different method, such as the transfer molding.

The method for producing a resin-molded product according to the first embodiment includes the process of cutting the resin-molded product in addition to the processes of the resin-molding method. However, the method for producing a resin-molded product according to the present invention is not limited to such a case. For example, an additional process may also be included along with the process for molding a resin (e.g. compression-molding process) by the resin-molding method according to the present invention, or there may be no such additional process included. The additional process may be different from the cutting process mentioned earlier.

The previously described embodiments have been concerned with the case where the resin-sealed surface (molded surface) of the resin-molded product will be flat when the die surfaces of the upper and lower dies are parallel to each other. Depending on the properties of the resin used for the resin molding, the operation of clamping the molding die with the die surfaces of the upper and lower dies being parallel to each other may cause the resin-molded surface of the resin-molded product to be warped after the die is opened. In such a case, the warpage should be taken into account in adjusting the arrangement and/or other factors related to the adjustment members in the flatness adjuster.

### REFERENCE SIGNS LIST

10, 30 . . . Resin-Molding Device
11 . . . First Platen (Upper Platen)
12 . . . Second Platen (Lower Platen)
131, 331 . . . Pedestal
132, 332 . . . Tie Bar
133, 333 . . . Toggle Link
14 . . . Flatness Adjuster
141, 145, 341, 541 . . . Adjustment Member
142 . . . Adjustment Member Holder Portion
143, 343 . . . Adjustment Member Container
144 . . . Attachment
151 . . . Upper Heater Plate
152 . . . Lower Heater Plate
16 . . . Molding Die
161 . . . Upper Die
162 . . . Lower Die
1621 . . . Lower-Die Base Plate
1622 . . . Lower-Die Side Block
1623 . . . Bottom-Surface Member
1624 . . . Elastic Member
1625 . . . Side-Surface Member
171, 173, 175 . . . O-Ring
172 . . . Lower Ambient Air Blockage Member
174 . . . Upper Ambient Air Blockage Member
18 . . . Adjustment-Mechanism Side Block
191 . . . Upper-Die Side Block
192 . . . Pressing Plate
193 . . . Bolt
21 . . . Electronic Part
22 . . . Substrate
23 . . . Release Film
24 . . . Resin Material
25 . . . Molten Resin
26 . . . Cured Resin
321 . . . Upper Movable Platen
322 . . . Lower Movable Platen
34A . . . First Flatness Adjuster
34B . . . Second Flatness Adjuster
351A . . . First Upper Heater Plate
352A . . . First Lower Heater Plate
351B . . . Second Upper Heater Plate
352B . . . Second Lower Heater Plate
36A . . . First Molding Die
361A . . . First Upper Die
362A . . . First Lower Die
36B . . . Second Molding Die
361B . . . Second Upper Die
362B . . . Second Lower Die
40 . . . Resin-Molding System
41 . . . Molding Module
411 . . . Auxiliary Transfer Mechanism
42 . . . Resin-Material-and-Substrate Refilling Module
421 . . . Resin-Material Refilling Device
422 . . . Substrate Storage Unit
43 . . . Resin-Molded-Product Unloading Module
431 . . . Resin-Molded-Product Storage Unit
44 . . . Transfer Mechanism
45 . . . Resin-Material-and-Substrate Supply Device
46 . . . Resin-Molded-Product Unloading Device
54 . . . Flatness Adjuster
542 . . . Bolt
543 . . . Adjustment Pin
C . . . Cavity

1. A resin-molding device, comprising:
a) a first platen and a second platen;
b) a first molding die to be attached to the first platen;
c) a second molding die to be attached to the second platen and arranged so as to face the first molding die;
d) a die-clamping mechanism for clamping the first molding die and the second molding die together by decreasing a distance between the first platen and the second platen, and for separating the first molding die and the second molding die from each other by increasing the distance between the first platen and the second platen; and
e) a flatness adjuster including an adjustment member for adjusting a parallelism between a die surface of the first molding die and a die surface of the second molding die, or a flatness of a resin-molded product to be molded with the first molding die and the second molding die.

2. A resin-molding device, comprising:
a) a first platen and a second platen;
b) a first molding die to be attached to the first platen;
c) a second molding die to be attached to the second platen and arranged so as to face the first molding die, the second molding die including a bottom-surface member and a side-surface member constituting a cavity;
d) a die-clamping mechanism for clamping the first molding die and the second molding die together by decreasing a distance between the first platen and the second platen, and for separating the first molding die and the second molding die from each other by increasing the distance between the first platen and the second platen; and
e) a flatness adjuster to be arranged between the first platen and the first molding die, the flatness adjuster including an adjustment member for adjusting a parallelism between a die surface of the first molding die and a die surface of the second molding die, or a flatness of a resin-molded product to be molded with the first molding die and the second molding die.

3. The resin-molding device according to claim 1, further comprising:
a support member located on the first molding die on a side opposite from the first platen, for supporting or holding the first molding die; and
a fixation member for fixing and releasing the support member onto and from the first platen while the first molding die is being supported or held by the support member,
wherein the flatness adjuster is allowed to be inserted into and removed from a space between the first platen and the first molding die when the support member is released from the first platen.

4. The resin-molding device according to claim 1, wherein the flatness adjuster is attachable and removable while the first molding die and the second molding die is held between the first platen and the second platen.

5. The resin-molding device according to claim 1, wherein:
the flatness adjuster includes a plurality of the adjustment members; and
at least one of the plurality of the adjustment members differs from the other adjustment members in terms of a length in a direction in which the distance between the first platen and the second platen is decreased and increased.

6. The resin-molding device according to claim 1, wherein:
the flatness adjuster includes a plurality of the adjustment members; and
at least one of the plurality of the adjustment members differs from the other adjustment members in terms of an area at a cross section orthogonal to a direction in which the distance between the first platen and the second platen is decreased and increased.

7. The resin-molding device according to claim 1, wherein:
the flatness adjuster includes a plurality of the adjustment members; and
at least one of the plurality of the adjustment members differs from the other adjustment members in terms of rigidity.

8. The resin-molding device according to claim 1, further comprising:
an attachment mechanism for attaching the first molding die to the first platen in a freely removable form.

9. The resin-molding device according to claim 1, wherein one of the first platen and the second platen is a fixed platen in an immobile state, and the other one is a movable platen.

10. The resin-molding device according to claim 1, comprising three or more platens in which a molding die is to be arranged between the neighboring platens, wherein the three or more platens include at least two platens neighboring each other and configured as the first platen and the second platen.

11. A resin-molding system, comprising:
a molding module including the resin-molding device according to claim 1, the molding module configured to allow a plurality of the molding modules to be connected to each other;
a resin-material supply device for supplying a resin material to each molding die in one or a plurality of the molding modules;
a resin-material refilling module including a resin-material refilling device for refilling the resin-material supply device with the resin material; and
a transfer mechanism for transferring the resin-material supply device, the transfer mechanism extending through the one or plurality of the molding modules and the resin-material refilling module when the one or plurality of the molding modules and the resin-material refilling module are connected.

12. A resin-molding method, comprising:
a preparation process including a step of preparing: a first platen and a second platen; a first molding die to be attached to the first platen; a second molding die to be attached to the second platen and arranged so as to face the first molding die; a die-clamping mechanism for clamping the first molding die and the second molding die together by decreasing a distance between the first platen and the second platen, and for separating the first molding die and the second molding die from each other by increasing the distance between the first platen and the second platen; and a flatness adjuster including an adjustment member for adjusting a parallelism between a die surface of the first molding die and a die surface of the second molding die, or a flatness of a resin-molded product to be molded with the first molding die and the second molding die; and
a die-clamping process including a step of clamping the first molding die and the second molding die together.

13. A resin-molding method, comprising:
a preparation process including a step of preparing: a first platen and a second platen; a first molding die to be attached to the first platen; a second molding die to be attached to the second platen and arranged so as to face the first molding die, the second molding die including a bottom-surface member and a side-surface member constituting a cavity; a die-clamping mechanism for clamping the first molding die and the second molding die together by decreasing a distance between the first platen and the second platen, and for separating the first molding die and the second molding die from each other by increasing the distance between the first platen and the second platen; and a flatness adjuster to be arranged between the first platen and the first molding die, the flatness adjuster including an adjustment member for adjusting a parallelism between a die surface of the first molding die and a die surface of the second molding die, or a flatness of a resin-molded product to be molded with the first molding die and the second molding die;
a target-object supply process including a step of supplying an object to be molded to the first molding die;
a resin-material supply process including a step of supplying a resin material to the cavity of the second molding die; and
a die-clamping process including a step of clamping the first molding die and the second molding die together.

14. A method for producing a resin-molded product, comprising a step of producing a resin-molded product by the resin-molding method according to claim 12.

15. The resin-molding device according to claim 2, further comprising:
a support member located on the first molding die on a side opposite from the first platen, for supporting or holding the first molding die; and
a fixation member for fixing and releasing the support member onto and from the first platen while the first molding die is being supported or held by the support member,
wherein the flatness adjuster is allowed to be inserted into and removed from a space between the first platen and the first molding die when the support member is released from the first platen.

16. The resin-molding device according to claim 2, wherein the flatness adjuster is attachable and removable while the first molding die and the second molding die is held between the first platen and the second platen.

17. The resin-molding device according to claim 2, wherein:
the flatness adjuster includes a plurality of the adjustment members; and
at least one of the plurality of the adjustment members differs from the other adjustment members in terms of a length in a direction in which the distance between the first platen and the second platen is decreased and increased.

18. The resin-molding device according to claim 2, wherein:
the flatness adjuster includes a plurality of the adjustment members; and
at least one of the plurality of the adjustment members differs from the other adjustment members in terms of an area at a cross section orthogonal to a direction in which the distance between the first platen and the second platen is decreased and increased.

19. The resin-molding device according to claim 2, wherein:
the flatness adjuster includes a plurality of the adjustment members; and
at least one of the plurality of the adjustment members differs from the other adjustment members in terms of rigidity.

20. The resin-molding device according to claim 2, further comprising:
an attachment mechanism for attaching the first molding die to the first platen in a freely removable form.

21. The resin-molding device according to claim 2, wherein one of the first platen and the second platen is a fixed platen in an immobile state, and the other one is a movable platen.

22. The resin-molding device according to claim 2, comprising three or more platens in which a molding die is to be arranged between the neighboring platens, wherein the three or more platens include at least two platens neighboring each other and configured as the first platen and the second platen.

23. A resin-molding system, comprising:
a molding module including the resin-molding device according to claim 2, the molding module configured to allow a plurality of the molding modules to be connected to each other;
a resin-material supply device for supplying a resin material to each molding die in one or a plurality of the molding modules;
a resin-material refilling module including a resin-material refilling device for refilling the resin-material supply device with the resin material; and
a transfer mechanism for transferring the resin-material supply device, the transfer mechanism extending through the one or plurality of the molding modules and the resin-material refilling module when the one or plurality of the molding modules and the resin-material refilling module are connected.

24. A method for producing a resin-molded product, comprising a step of producing a resin-molded product by the resin-molding method according to claim 13.
